(19) United States
(12) Patent Application Publication
(10) Pub. No.: US 2006/0174771 A1
(43) Pub. Date: Aug. 10, 2006

(54) Assembly for creating milk froth and for heating milk

(75) Inventor: Patrizio Frigeri, Uster (CH)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Saeco IPR Limited, Dublin 12 (IE)

(21) Appl. No.: 11/345,442

(22) Filed: Feb. 1, 2006

(30) Foreign Application Priority Data
Feb. 8, 2005 (CH) 00194/05

(51) Int. Cl. A23C 1/00

(52) U.S. Cl. 99/279; 99/452

(57) ABSTRACT

An assembly for creating milk froth and/or for heating milk is disclosed. It comprises a milk container, a foaming device and a valve assembly. The foaming device is provided with a steam supply channel, an air supply channel, a milk supply channel and a discharge opening. In order to be in a position to vent the foaming device after milk having been heated or foamed, a venting channel is provided, adapted to be closed by means of the valve assembly, and to communicate with the ambient air, respectively.

### BACKGROUND OF THE INVENTION

The present invention refers to an assembly for creating milk froth and for heating milk, comprising a foaming device including a steam supply channel, an air supply channel, a milk supply channel, and a discharge opening.

For creating milk froth, so-called milk foaming devices or emulsifying devices are known in various embodiments. Usually, these milk foaming devices or emulsifying devices comprise a steam supply channel, opening into a suction chamber. The suction chamber communicates with a milk supply channel and an air supply channel. By means of the steam flow, a negative pressure is created in the suction chamber, said negative pressure causes milk to flow via the milk supply channel into the suction chamber and air to flow via the air supply channel into the suction chamber. The so created mixture of steam, air and milk is brought into a turbulent flow in a subsequent emulsifying chamber, with the result that a homogenous milk froth is created. The milk froth created by such a foaming device can be used, for example, for preparing a Cappuccino beverage or a “Latte Macchiato” beverage. Besides creating milk froth, such a foaming device usually can also be used to heat milk, whereby in such a case the supply of air is interrupted.

### PRIOR ART

The publication EP 0,195,750 discloses an emulsifier unit particularly for emulsifying steam and milk to prepare “cappuccino's”. The emulsifier comprises a nozzle body member, connected to a steam generator. The nozzle body member is inserted into a tubular body member, opening tangentially into a cylindrical emulsifying chamber. The latter one comprises, at its bottom, a discharge opening. In the interior of the tubular body member, a suction chamber is created into which opens, at its top, an air supply inlet and, at its bottom, a milk supply inlet. Upon feeding steam into the suction chamber, a negative pressure is created therein, causing the aspiration of milk and air. The mixture of water, steam, air and milk is tangentially fed into the emulsifying chamber in which it is brought into a turbulent flow, which supports the emulsifying process and causes the steam to condensate. The so created emulsion leaves the device through the discharge opening.

### OBJECTS OF THE INVENTION

It is an object of the invention to provide an assembly for creating milk froth and for heating milk that is of simple straight-forward design. It is a further object of the invention to provide an assembly for creating milk froth and for heating milk in which milk residues in the foaming device can quickly be drained after the creation of milk froth or the heating of milk has been done.

### SUMMARY OF THE INVENTION

To meet these and other objects, the present invention provides an assembly for creating milk froth and for heating milk, comprising a foaming device including a steam supply channel, an air supply channel, a milk supply channel, a discharge opening, and a valve assembly. The foaming device further comprises a venting channel by means of which the foaming device is vented after milk foam has been created or milk has been heated. The valve assembly comprises means for selectively closing the venting channel and the air supply channel, depending on the mode of operation of the assembly.

### BRIEF DESCRIPTION OF THE DRAWINGS

In the following, an embodiment of the assembly according to the invention will be further described, with reference to the accompanying drawings, in which:

FIG. 1 shows an exploded perspective view of the assembly for creating milk froth and for heating milk;

FIG. 2 shows a longitudinal sectional view of the assembly of FIG. 1 in an assembled state; and

FIG. 3 shows a cross sectional view of the valve assembly of FIG. 2.

### DETAILED DESCRIPTION OF A PREFERRED EMBODIMENT

The assembly for creating milk froth and for heating milk is designated, as a whole, by reference numeral 1. Essentially, the assembly 1 comprises a foaming device 2, a milk container 3, a coupling element 4 as well as a valve assembly 5. Moreover, a cover 3a for closing the milk container 3 is shown in the drawing.

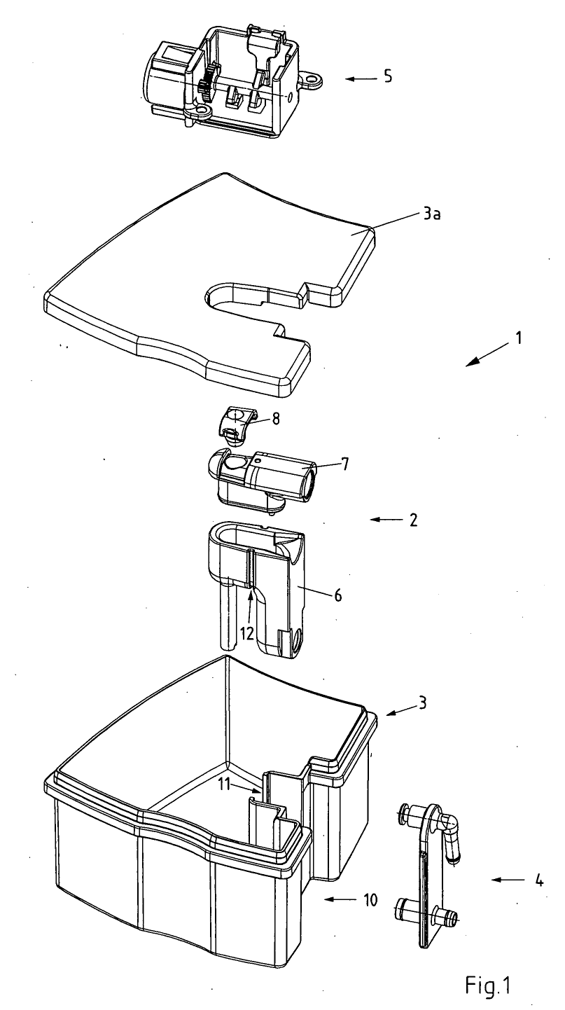

The foaming device 2 comprises a lower portion 6, an upper portion 7 and a valve insert 8, the elements 6 and 7 being attached to each other by means of a push-fit connection. Furthermore, a valve insert 8 is illustrated in FIG. 1, adapted to be inserted into the top of the upper portion 7, as will be further explained herein after. The milk container is provided with a recess 10, opening into a slot-shaped cutout 11. The foaming device 2 is provided with a groove-shaped slot by means of which it can be attached to the recess 11 of the milk container 3.

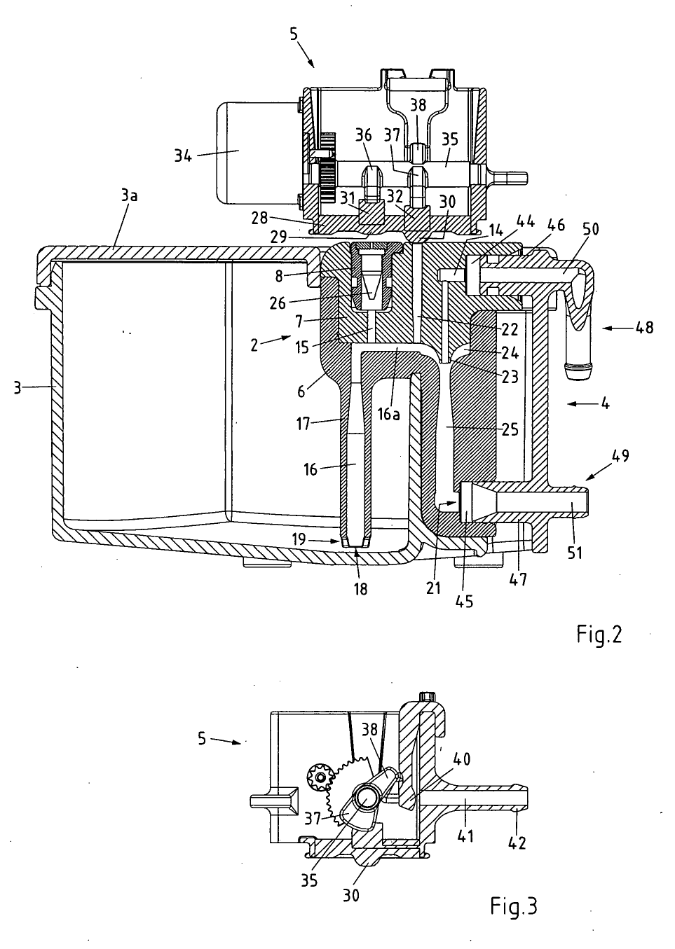

FIG. 2 shows a longitudinal sectional view of the assembly of FIG. 1 in an assembled state. In this view, the lower portion 6 of the foaming device 2 is not sealingly attached to the upper portion 7; thus, the required sealing gaskets are not shown in this drawing. The foaming device 2 attached to the milk container 3 comprises a steam supply channel 14, an air supply channel 15, a milk supply channel 16, an outlet opening 21 as well as a venting channel 22. Both the venting channel 22 and the air inlet channel 15 open into the foaming device 2 at its end face. The horizontally extending portion of the milk supply channel is designated by reference numeral 16a. The end of the steam supply channel 14 is designed as a nozzle 23, opening into a negative pressure chamber 24 connecting the milk supply channel 16 with a mixing channel 25. The valve insert 8 inserted into the air supply channel 15 is provided with a check valve 26 in the form of a lip valve.

At the top of the foaming device 2, the valve assembly 5 is located. The valve assembly comprises a silicon mat 28, the bottom side thereof being provided with two protruding closure elements 29, 30 by means of which the air supply channel 15 and the venting channel 22 can be sealed at their opening end. The top side of the silicon mat is provided with two embossments 31, 32, located correspondingly with regard to the closure elements 29, 30. The opening and closing of the valves is performed by means of a cam shaft 35 driven by a stepper motor 34. The cam shaft 35 is provided with three cams 36, 37, 38 by means of which the two closure elements 29, 30 of the silicon mat 28 as well as a further closure body, located at the rear of the valve assembly 5, are actuated. The further closure body 40 is shown in the illustration of FIG. 3. In the view according to FIG. 2, the venting channel 22 is sealed by means of the closure element 30, while the air supply channel 16 communicates with the ambient air via the closure element 29.

The foaming device 2 is further provided with a trunk-shaped appendage 17, extending towards the bottom of the milk container 3. It contains the milk supply channel 16, and the distal end thereof has an inlet opening 18 communicating with the milk supply channel 16. The appendage 17 is provided, in the region of its inlet opening 18, with two diametrically opposite, radially extending cutouts 19, which favor the entry of milk from the milk container 3 into the appendage 17. At the inlet of the steam supply channel 14, a cylindrical recess 44 is provided in the foaming device 2. The outlet opening 21 opens into a cylindrical recess 45, too.

The coupling element 4 is provided with two cylindrical stubs 46, 47, the distance between the two stubs 46, 47 corresponding to the distance between the two cylindrical recesses 44, 45, and the outer diameter thereof matching the diameter of the two cylindrical recesses 44, 45 to enable a leak proof plug and socket connection between the particular stub 46 and 47, respectively, and the particular recesses 44 and 45, respectively. The two cylindrical stubs communicate in each case via a bore 50 and 51, respectively, with a connecting flange 48 and 49, respectively. Thereby, the upper connecting flange 48 is adapted to receive a hose (not shown) running to a steam source (not shown), while the lower connecting flange 49 is adapted to receive a hose (not shown) running to a beverage outlet (not shown).

The mode of operation of the assembly 1 can be explained as follows:

In order to produce foamed milk, the closure element 29 located at the inlet of the air supply channel 15 is displaced into its open position, while the closure element 30 located at the inlet of the venting channel 22 is displaced to its closed position. This condition is schematically shown in FIG. 2. The operation of the closure elements 29, 30 is performed by triggering the stepper motor 34, rotating the cam shaft 35 into such a position in which the cams 36 and 37 press the associated embossments 31 and 32 downwards. In the rotational position of the camshaft 35 shown in FIG. 2, the cam 37 presses the embossment 32 downwards, such that the latter one presses the closure element 30 onto the mouth of the venting channel 22, thereby sealingly closing it. Now, steam is supplied via the steam supply channel 14. The steam enters the mixing channel 25 through the nozzle 23 and creates a negative pressure in the chamber 24. The negative pressure in the chamber 24 has two effects: First, milk is sucked into the milk supply channel 16 via the appendage 17, and second, the negative pressure results in an opening of the check valve 26 inserted into the air inlet channel 15, with the result that air flows via the air inlet channel 15 into the horizontally extending portion 16a of the milk supply channel 16. The air flowing in through the air inlet channel 15 is mixed with the milk flowing through the portion 16a of the channel 16. Downstream the nozzle 23, the milk mixes with the steam which thereby condensates almost immediately. By that condensation reaction, the suction effect in the region of the nozzle is even boosted. The mixture of air, milk, steam and water, respectively, flows into the mixing channel 25 in which a homogenous milk froth is created, escaping from the foaming device 2 through the outlet opening 21 and flowing, through the bore 51 in the cylindrical stub 47 of the coupling element 4, into the connecting flange 49. Therefrom, it can flow to the beverage outlet via not shown duct means.

For ending the milk foam production, the supply of steam is stopped, with the result that the pressure in the negative pressure chamber 24 raises and the check valve 26 closes. After the milk having been foamed, the closure element 30 closing the venting channel 22 is displaced into its open position; thereby, any milk residues still present in the foaming device 2 are drained thereof. Again, displacing the closure element 30 into its open position is performed by triggering the stepper motor 34, rotating the cam shaft 35 into the corresponding position. By venting the foaming device 2, and in the case where the milk discharge opening is located below the milk container 3, it is simultaneously avoided that milk can continue to flow out of the milk container 3 under the influence of the principle of communicating tubes.

For warming or heating milk, both the closure element 29 located at the inlet of the air supply channel 15 and the closure element 30 located at the inlet of the venting channel 22 are brought into their closed positions. Thereafter, again via the steam supply channel 14, steam is supplied, flowing through the nozzle 23 into the mixing channel 25. The negative pressure zone in the region of the nozzle 23, generated by the flowing steam, results in sucking in milk into the milk supply channel 16 via the appendage 17; however, air is prevented to flow into the horizontally extending portion 16a of the milk supply channel 16. In this way, milk can be heated quickly and easily.

In order to ensure that the milk-containing duct portions, bores and channels 16, 16a, 24, 25, 51 are drained after a foaming or heating cycle, the closure element 30 located at the inlet of the venting channel 22 is brought into its open position after each operation cycle.

FIG. 3 shows the valve assembly 5 in a cross sectional view. In this illustration, the closure body member 40 is clearly visible, by means of which a venting bore 41 running through a stub 42 can be closed. The stub 42 is adapted to receive a venting hose (not shown), which is connected to a beverage duct (not shown) by means of a suitable coupling member. The closure body member 40 is operated by a cam 38 provided on the cam shaft 35.

Preferably, all channels of the foaming device are provided with a surface constituted by nano-particles, being both hydrophobic and oleophobic and in which at least some of the nanoparticles consist at least partially of silver or a silver compound. By providing such a surface, the foaming device 2 is easy to clean and, additionally, provides anti-microbial activity. With the expression “nano-particles”, particles should be understood that have a dimension of between 10⁻¹⁰ to 10⁻⁷ m, preferably approximately 10⁻⁸ m.

Even if the assembly is relatively unsusceptible to contamination, it should be cleaned regularly. This can be performed either by means of a flushing program in which at least the ducts, bores and channels 16, 21, 24, 25, 45, 51, which are critical as far as contamination is concerned, are flushed with hot water. Or, another possibility consists in manually removing the coupling element 4 from the foaming device 2 and to lift the foaming device 2 off the milk container 3. Thereafter, the upper portion 7 of the foaming device 2 can be pulled off the lower portion 6 with the result that the inner parts of the foaming device, which are critical as far as contamination is concerned, particularly the horizontally extending portion 16a of the milk supply channel 16 as well as the nozzle 23 and the negative pressure chamber 24, are exposed. Alike, the valve insert 9 can be removed. The afore mentioned parts and elements then can be cleaned in a dish washer.

1. An assembly for creating milk froth and for heating milk, comprising:
A foaming device including a steam supply channel, an air supply channel, a milk supply channel, and a discharge opening; and
a valve assembly;
said foaming device further comprising a venting channel by means of which the foaming device is vented after milk foam having been created or milk having been heated;
said valve assembly comprising means for selectively closing said venting channel and said air supply channel, depending on the mode of operation of the assembly.

2. An assembly according to claim 1, in which said valve assembly comprises a first closure element adapted to close said air supply channel and a second closure element adapted to close said venting channel.

3. An assembly according to claim 1, in which said valve assembly further comprises a venting bore communicating with a beverage duct, and a closure body member adapted to close and vent, respectively, said venting bore.

4. An assembly according to claim 1, in which said valve assembly is operable by electro-motoric, electromagnetic, hydraulic or pneumatic actuating means.

5. An assembly according to claim 2, in which said valve assembly comprises a stepper motor and a cam shaft driven by said stepper motor, said cam shaft having cams for actuating said first and second closure elements and said closure body member.

6. An assembly according to claim 1, in which both said venting channel and said air supply channel open into said foaming device at its end face, a silicon mat being located above the mouths of said venting channel and said air supply channel, said silicon mat having two closure elements for closing said venting channel and said air supply channel, respectively, whereby said two closure elements are actuated by a cam shaft driven by an electro motor.

7. An assembly according to claim 3, in which said closure body member is actuated by cam shaft driven by an electro motor.

8. An assembly according to claim 1, in which said foaming device further comprises a nozzle located at the outlet end of said steam supply channel, a negative pressure chamber including an inlet and an outlet, and a mixing channel, said inlet of said negative pressure chamber communicating with said milk supply channel and said outlet of said negative pressure chamber communicating with said mixing channel.

9. An assembly according to claim 1, in which said venting channel is communicating with said milk supply channel.

10. An assembly according to claim 1, further comprising a check valve located in said air supply channel, said check valve being adapted to open once said first closure element is in its open position and once a predetermined negative pressure in said negative pressure chamber, generated by the supply of steam, is reached.

11. An assembly according to claim 1, further comprising a milk container to which said foaming device is releasably attached.

12. An assembly according to claim 11, in which said foaming device comprises an appendage extending towards the bottom of said milk container, said milk supply channel being located in said appendage and having, at its distal end, an inlet opening communicating with said milk supply channel.

13. An assembly according to claim 12, in which said appendage is provided with at least one radial cutout located in the region of said inlet opening.

14. An assembly according to claim 1, in which said foaming device consists of several parts, whereby the individual parts are attached to each other by means of push-fit connections or by means of snap-on connections.

15. An assembly according to claim 13, in which said milk supply channel is at least partially exposed once said several parts of said foaming device are separated from each other.

16. An assembly according to claim 1, in which said foaming device comprises a first cylindrical recess, communicating with said steam supply channel.

17. An assembly according to claim 1, in which said foaming device comprises a second cylindrical recess, communicating with or constituting said discharge opening.

18. An assembly according to claim 16, in which said foaming device comprises a coupling element provided with two cylindrical stub members, said stub members being adapted to be inserted into said first and second cylindrical recesses, one of said stub members being connectable to a steam supply hose and the other of said stub members being connectable to a discharge hose.

19. An assembly according to claim 1, in which at least said steam supply channel, said air supply channel, said milk supply channel, said nozzle and said negative pressure chamber are provided with a hydrophobic and eleophobic surface layer constituted by nanoparticles, consisting at least partially of silver or a silver compound.

20. An assembly according to claim 1, adapted to be used together with an espresso coffee machine or being integrated into an espresso coffee machine.

21. (canceled)

22. An assembly according to claim 2, in which said valve assembly further comprises a venting bore communicating with a beverage duct, and a closure body member adapted to close and vent, respectively, said venting bore.

23. An assembly according to claim 3, in which said valve assembly comprises a stepper motor and a cam shaft driven by said stepper motor, said cam shaft having cams for actuating said first and second closure elements and said closure body member.

24. An assembly according to claim 2, further comprising a check valve located in said air supply channel, said check valve being adapted to open once said first closure element is in its open position and once a predetermined negative pressure in said negative pressure chamber, generated by the supply of steam, is reached.

25. An assembly according to claim 8, further comprising a check valve located in said air supply channel, said check valve being adapted to open once said first closure element is in its open position and once a predetermined negative pressure in said negative pressure chamber, generated by the supply of steam, is reached.

26. An assembly according to claim 17, in which said foaming device comprises a coupling element provided with two cylindrical stub members, said stub members being adapted to be inserted into said first and second cylindrical recesses, one of said stub members being connectable to a steam supply hose and the other of said stub members being connectable to a discharge hose.

27. An assembly according to claim 8, in which at least said steam supply channel, said air supply channel, said milk supply channel, said nozzle and said negative pressure chamber are provided with a hydrophobic and eleophobic surface layer constituted by nanoparticles, consisting at least partially of silver or a silver compound.
